(19) United States
(12) Patent Application Publication
(10) Pub. No.: US 2004/0003117 A1
(43) Pub. Date: Jan. 1, 2004

(54) Method and apparatus for dynamic optimization and network delivery of multimedia content

(76) Inventors: Bill McCoy, Seattle, WA (US); Keith Fieldhouse, Seattle, WA (US)

Correspondence Address: JAMES L DAVISON, PICTURE IQ CORPORATION, 600 STEWART STREET SUITE 1601, SEATTL, WA, 98101, US

(21) Appl. No.: 10/169,650

(22) PCT Filed: May 17, 2001
(86) PCT No.: PCT/US01/16080

(51) Int. Cl. G06F 15/16

(52) U.S. Cl. 709/246

(57) ABSTRACT

This invention relates to efficiently transmitting images or other multimedia data with the appropriate properties over a network. The original source image data or other multimedia data that resides on a networked server may not have the appropriate characteristics for optimal transmission. The present invention describes a method for converting original source image data or other multimedia data into appropriately characterized data “on the fly”. The administrator of the networked system containing the images or other multimedia data desired for transmission can apply rules as to what properties the image or other multimedia data must possess for efficient transmission. The present invention analyzes the conditions accompanying the image or other multimedia data request, determines the properties the image data or other multimedia data should contain, checks to see if an image or other multimedia data possessing those properties has already been rendered and stored in the memory cache and, if not, then sends the original source image or the original source multimedia data to a conversion engine wherein the source image or other multimedia data is converted to an image or other multimedia data that possess the correct properties to be effectively transmitted. The invention makes available to the network administrator a predetermined set of default rules that can handle many of the conditions typically encountered in an image or other type of multimedia data request, however the network administrator can later modify these rules.

This application claims benefit of priority under 35 U.S.C. 119(e) of U.S. Provisional Application No. 60/264,339, filed Jan. 26, 2001 and entitled “NETWORK SERVER APPLIANCE FOR IMAGING SERVICES” which is incorporated by reference in its entirety.

### BACKGROUND

1. Field

The invention relates to digital multimedia content processing systems. A multimedia content rendering server method and apparatus thereof are described.

2. Description of Related Art

Regardless of what device is used to access the Internet or other network, efficient and reliable delivery of multimedia content is vital to the experience. However, delivering visually compelling content for the Web or other networks has become increasingly difficult with the assortment of formats, languages, network constraints, and device capabilities. Some companies create multiple Web sites specifically designed for each targeted device. While providing full control over the output, each Web site must be updated separately when changes occur. Not only does the text need to change, thousands of images and other multimedia content need to be edited for the particular size and format. In addition, stockpiling multiple copies of the same image or other multimedia content quickly consumes expensive storage space. Overall, this translates into a costly and time-consuming practice.

The present invention provides a robust, scalable, and secure infrastructure solution that enables enterprises, content creators, and service providers to dynamically optimize and deliver images or other multimedia content over the Internet or other network. Using this technology, companies can deliver optimized images or other multimedia content to any device while improving network performance.

The rollout of advanced wireless network technologies has fueled the delivery of Web-enabled devices such as mobile phones and personal digital assistants. However, the technology itself can be a barrier. Different formats, markup languages, device capabilities and network constraints threaten to limit the promise of mobile computing. In many cases, cumbersome devices, poor connections, and different wireless formats have resulted in a poor user experience. This has helped prevent widespread adoption. However, in some countries, the mobile phone is by far the dominant Internet access device. There are, as this is written, now over 33 million mobile Internet users. This explosion of mobile Internet access has made Web site design and delivery significantly more complicated. The preferred option is to utilize content management or dedicated transcoding systems that translate Web pages, originally designed for the PC, into the different markup languages required for mobile devices. These solutions typically provide one or more of the following transformations:

HTML to compact HTML (cHTML)

HTML to Wireless Markup Language (WML)

HTML to Handheld Device Markup Language (HDML)

Utilizing content management or transcoding systems can improve time to market and may be more cost-effective than building isolated and disconnected sites from the ground up. Updates and changes automatically propagate across multiple sites. However, heuristics-based automatic translation rarely achieves acceptable results and programming is required where the transformation falls short. In addition, these solutions focus on Web site text but not images or other multimedia content. Since only the textual portion is converted, the Web production staff is still burdened with manually editing and storing a multiplicity of images or other multimedia content, potentially per device type.

Quality of Service (QoS) means a high quality user experience, measured in low latencies of network content delivery. For example, Web site producers and IT professionals are constantly dealing with the trade-offs between exciting visual content and acceptable Web performance. Even the most visually inspiring Web site will drive away site visitors if it doesn't perform well. It would be much easier to design Web sites if all users had the same connection speed and display capabilities. However, wireless, DSL, cable, LAN, and dial-up connections all operate at different speeds and levels of reliability. Most wireless connections have a limited bandwidth of data transmission speeds and their performance is very unpredictable. What is needed is a transcoding system that can dynamically adapt itself to meet the needs of the various types of network connections. That way, higher quality rich content can be generated for high-bandwidth connection, but smaller lower-quality content can be generated for slower modem or wireless network connections.

Current server systems are mainly based on IIP (Internet Imaging Protocol). Using IIP, the client (typically a Web browser) requests a particular resolution of an image. The server will generate the pixels at the desired resolution and return them to the client (packaged up as JPEG or FlashPix). Also using IIP, the client can also request a section (or tile) of the image at a particular resolution. This permits the user to pan or zoom the photo via the Web browser. Particular portions of the image (via zoom/pan/resolution) are requested via a command encoded inside the URL request. It includes the section (tiles) of the image and the particular resolution. Using JavaScript/DHTML or Java, the client browser will execute the code that requests the necessary image data (via and encoded URL string).

While IIP and the present invention both improve the user experience when viewing images on the Web, they approach the problem differently, and solve two different problems. IIP is mainly used to provide user interaction with images on the Web page. The present invention is used to dynamically (and automatically) optimize the generation and delivery of image data or other multimedia content. It would be difficult to use IIP for every image on a Web site, since too many network resources would be required. While IIP does a reasonable job in allowing the user to interact with an image, it is a complex solution. Additional HTML/JavaScript/Java code must be developed and added to Web page to enable this functionality. Further, this additional code must be executed on the client.

IIP is focused on serving up portions of JPEG or FlashPix images to the client. In general, some master JPEG or FlashPix image is always available and is how the smaller portions of the image are served up. This is similar in some regards to the present invention. However, there is no transcoding being performed, except maybe between JPEG and FlashPix (which internally are very similar/DCT based compression).

Another advantage with the present invention is that it's easily integrated into the user's network/system. Using the Internet as an example, only a minor modification to the user's Web site is required. Furthermore, the present invention makes it easy to modify the rules and conditions that dictate how images or other multimedia content are generated so future changes are possible with no modification to the user's Web site.

The Web is recognized as an important channel for commerce, communication, and research. Besides providing business efficiencies, a Web site can often represent the closest interaction that a company often has with its customers, job seekers, partners, and investors. As a result, positive impressions by the use of images have become an important force behind Web site design and content creation.

Many Web sites, such as those in the news or media sector, must provide fresh image or other multimedia content several times a day in order to remain competitive and provide news as it happens. E-Commerce sites add new product images on a daily basis and maintain product catalogs with hundreds or thousands of photos and images.

Images, in particular, are typically acquired from news wires, data feeds, CD-ROM, digital cameras, or digital scans or images created from scratch. As a result, the original images arrive in a variety of file formats, sizes, and resolutions. Using tools such as Adobe® PhotoShop®, Web or other network production staff must manually edit each of these photos before they can be published. At minimum, two copies of the image must be stored—the original and the published image. Sites that provide “thumbnail” and “enlarged” versions of images add to this number and Web sites that seek to address different device and connection types increase this number even further.

### SUMMARY

This invention relates to delivering optimized multimedia content over a computer network. The method that accomplishes this task uses a computer system called a multimedia content server system that can analyze a number of conditions accompanying the multimedia content request. After these conditions are sorted through, the multimedia content server system can modify the original source multimedia content (the “master” content) properties, such as size and amount of detail needed, among others, and send that modified multimedia content to the requester instead of the original source multimedia content. Using an image as an example of the type of multimedia content that can be handled, an image requested for the delivery to the requester's PC can be a lot larger and contain more image detail than an image requested by a requester's cell phone. The present invention can determine what type of device is requesting the image and modify that image accordingly. The properties of the image that needs to be delivered can also be determined by how busy the network is at the time of the request. A large and more detailed image takes more time to deliver than a smaller and less detailed image. During periods of high network load, it is probably more efficient to send a smaller and less detailed image. The imaging server system can also store a particular image into multiple locations, each location containing the particular image, but with each image having different properties. When a request is received for an image and the conditions accompanying the request require a particular set of properties that the image should possess prior to transmission, the stored images can be searched to determine if an image with those properties is already present and if so then that image is transmitted. If no image possesses the correct properties then a request can be made to an imaging engine to use the original source image, transform it into an image with the appropriate properties, and transmit that image to the requester. That transformed image is then stored into memory (stored in the cache) and is then made available to any another request that requires an image with those properties. The imaging server system can have its rules for what properties an image should possess depending on what conditions prevail at the time of the request, determined by the user interface provided. Once the properties based on the conditions is set they can be later modified using the same user interface made available.

Although many examples use the Internet based World Wide Web (the Web) it is evident that this system may be deployed over any type of network. Images are not the only type of multimedia that can employ this server system. The present invention also applies the delivery demands of audio, video and mixed media. These and other advantages of the present invention will become apparent upon reading the following detailed description and studying the various figures of the drawings.

### BRIEF DESCRIPTION OF THE DRAWINGS

FIG. 1 shows a typical client device requesting a Web page over the Internet.

FIG. 2 shows a flowchart describing the steps taken when an image request is made.

FIG. 3 shows a sample of devices for which an image made be modified.

### DETAILED DESCRIPTION OF THE PREFERRED EMBODIMENT

The present invention employs a powerful, plug-and-play multimedia content server system that dynamically prepares and optimizes images or other multimedia content for delivery to any Web-enabled or other network enabled device. It streamlines image or other multimedia content workflow, reduces costs, and optimizes site performance—all in a scalable server appliance that seamlessly integrates with an existing network infrastructure. In the best mode for carrying out the invention and using images as an example, the need to meticulously resize or format each image in order to meet network production requirements is eliminated. The preferred embodiment of the present invention dramatically reduces network site production costs by automatically converting original images into the desired resolution, size, and format. When a device requests an image, the original image is accessed and dynamically converted to meet the page, device, and associated data transmission speed requirements of the requesting client.

The invention is in effect a server system that resides with the Web servers on a network, typically packaged as a server appliance. In a typical network configuration, the server handles most of the image or other multimedia content requests for the network site. One of the innovative aspects of the present invention is that the multimedia content is created “on demand” based on the rules as defined by the creators of the network.

Delivering Multimedia Content to Any Device

One of the main challenges for enterprises is creating and delivering multimedia content to any device. The present invention answers this by providing a conversion engine that can transform, for example, original images into the desired sizes and formats. Images are transformed based on a set of rules created by IT or Web staff. For example, an imaging server system embodiment of the present invention can convert an original high-resolution TIFF image for the following devices:

PDA: 256 colors, 160×160, 5 k optimized JPEG

Mobile Phone: 256 colors, 80×100, 5 k optimized GIF

PC with Broadband Connection: 24-bit color, 800×600, and 75 k optimized PNG

This imaging server system can be used with content management or transcoding solutions to deliver both network text and images to any device. Organizations can quickly publish content designed to meet the needs of new Internet or other network access methods. In essence, the present invention helps “future-proof” Web sites or other networked systems. For Web sites using the imaging server embodiment:

1. When a client browser requests a Web page, all image requests are sent to the imaging server system while the Web servers handle requests for text and execution of server side business logic.

2. The imaging server system determines if the request is the first for the image or if it has been requested previously.

3. If the image has already been requested, the cache delivers it to the client browser.

4. If the image has not been previously requested, the imaging server system retrieves the original source image and the system's rendering engine then dynamically converts the image to the appropriate format.

5. Once the image is converted, it is placed in the imaging server cache and delivered to the requesting client.

It is obvious that creating multimedia content is a time consuming and labor-intensive process that can negatively effect time to market.

The imaging server embodiment of the present invention can dynamically convert original images to thumbnail, medium, and large views as well as resize the images for display on PC dial-up connections and three mobile phones. Instead of serving images from core Web or other network application servers, sites can cost-effectively offload this responsibility to the imaging server and significantly increase their scalability. In order to handle higher traffic needs, a cluster of image servers can be configured to seamlessly communicate with each other to distribute the cache of prepared images and to provide fail-over and high availability. In addition to off-loading the image serving process from Web sites, server demand rules can optimize bandwidth usage by serving smaller images at peak load times.

With the imaging server system, a Web or other network production staff only needs to make available the original images. The imaging server system embodiment will dynamically convert the originals to thumbnails, medium, and large views as well as resize the images for display on PC dial-up connections and three mobile phones. Therefore, instead of serving images from the core Web or other network application servers, sites can effectively offload this responsibility to the imaging server system and significantly increase their scalability. In order to handle higher traffic needs, a cluster of imaging server systems can be configured to communicate with each other to distribute the cache of prepared images and to provide fail-over and high availability. For example, a site administrator can create a rule that serves highly compressed images for a portion of the site if the traffic rate exceeds a particular threshold. Instead of “request failed” messages, site customers get successful page views. In addition, bandwidth costs—typically metered at 90% of peak usage—can be kept to a cost-effective level.

The present invention may be deployed in a data center alongside Web or other types of network servers. A cluster of server systems can be configured to seamlessly communicate with each other to distribute the cache of prepared multimedia content data and to provide fail-over and high availability. In addition, the multimedia content server system can be configured to prioritize either “greatest cache capacity” or “least loss of cache data” in the unlikely event of failure. The multimedia content server system is designed to easily integrate with existing Web site deployments. The only change that must be made is to point HTML content tags to the multimedia content server system instead of the server where content is currently found. Content tags can be changed on existing pages and new pages. Any new pages created will contain content tags that are “multimedia content server system aware”. Existing pages can be modified when most convenient. For images there are two ways most sites currently file and store their content, by filename or by directory. For example, the imaging server system embodiment easily accommodates both styles of storage.

Example of a filename-based site:

http.//www.company1.com/products/women/12302/images/12302t.jpg represents the thumbnail image

http://www.company 1.com/products/women/12302/images/12302m.jpg represents the medium sized image

http.//www.company1.com/products/women/12302/images/12302l.jpg represents the large image.

Each file is named to represent different image sizes.

To handle this scenario, the use of Filename Rules to tell the imaging server that when a file ending with a “t” is requested, a thumbnail should be delivered, “m” means a medium-sized image should be delivered, and “l” indicates a large image should be delivered.

Example of a directory-based site:

http://www.company2.com/11/39/97/Thumb/11399776.jpg

http://www.company2.com/11/39/97/Medium/11399776.jpg

http://www.company2.com/11/39/97/Large/11399776.jpg

Each directory is named to represent different image sizes.

In this scenario, the use of Path Rules to tell the imaging server that when a path ending with Thumb is requested, a thumbnail should be delivered, Medium means a medium-sized image should be delivered, and Large indicates a large image should be delivered.

Multimedia Content Server System Components

A network appliance is a device that provides a limited number of dedicated functions, and is therefore able to deliver those functions more cost-effectively than a multi-purpose device. By specializing in one particular area, an appliance often provides a richer feature set, superior stability and broader flexibility in terms of deployment and configuration. The preferred embodiment of the present invention is a network-enabled, sealed system, optimized for multimedia content delivery. There is no software to install or concern over compatibility issues. It is solely dedicated to high-performance delivery of multimedia content for any device. As a rack-mountable unit, the multimedia content server is conveniently located with other Web infrastructure -Web servers, databases, firewalls, load balancers, and cache servers.

This multimedia content server system is a “no-code” solution that dynamically adapts multimedia content for any Web-enabled device. Rules and properties are created through a point and click user interface that can be utilized by IT professionals and Web production staff. Rules can be based on a variety of criteria including the URL path, filename, server demand, browser type, and cookie content.

This multimedia content server system also ships with a set of pre-defined rules for the more common multimedia content conversion requirements. The pre-defined rules may meet the multimedia content delivery needs right out of the box. If not, these rules can be easily modified or new rules can easily be created to meet the system requirements. By monitoring the specifications of the latest mobile phone models and creating updated rules that support these models these rules can then be distributed to existing multimedia content server system deployments so that the rules are always current with the technology. A simple example of a rule is a Browser Type Rule. This type of rule tells the multimedia content server system how to adapt an image based on the type of requesting browser. For images, this rule has properties that combine to create a customized image, such as image source, height, width, and compression. Properties of a rule can be changed any time and from any environment, -no changes to individual Web pages are required.

A server demand rule can be used to better manage bandwidth during peak load times. Instead of adding more Web servers or reducing the quality and quantity of multimedia content for the whole site, use the multimedia content server system to automatically serve up lower quality content during high traffic periods.

A “cookie” rule (a cookie is a small data file placed by the server into the user's device that may be accessed later by that server) can be used to further customize the multimedia content properties that are most appropriate for delivery to that user's device.

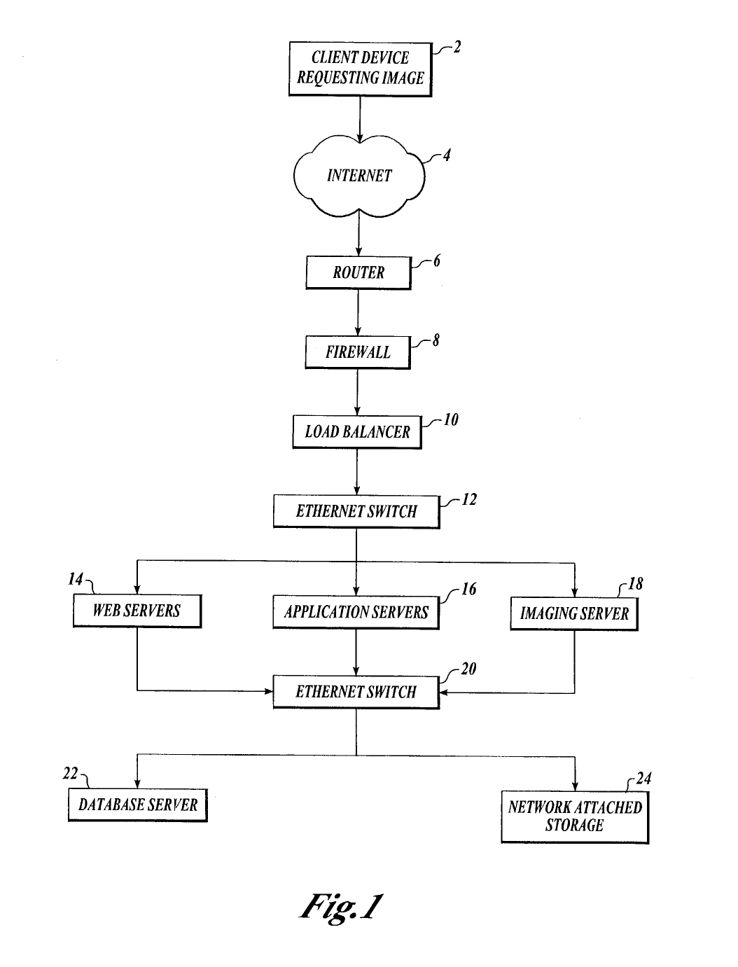

The following description details the embodiment of the invention that encompasses the delivery of images. FIG. 1 shows a client device 2 requesting a Web page over the Internet 4 using HTTP protocol over TCP/IP. The router 6, firewall 8, load balancer 10 and Ethernet connection 12, 20 are standard network components. Web sites that generate heavy traffic typically use both application servers 16 and Web servers 14. To facilitate the efficient transfer of images to match a number of prevailing conditions there is added the imaging server system 18 that is the basis for the image rendering embodiment of the present invention. There are three basic areas of operation of this imaging server system:

Raster Image Preparation—take original resolution raster image data (typically original resolution JPEGS) and process them for web use (for example by adjusting the size and compression quality of the image or be producing “progressive” JPEGS).

Image Transcoding—Similar to the above, but in addition to preparing the image, adapt the image for a variety of output devices (e.g., convert a JPEG image to a GIF image for iMode typically by automatically detecting that an iMode phone has requested the image)

Automated Image Creation—to the above, add the ability to create multi-source composites for the web. For example, provide the ability to add vector text and art to images to create banner advertisements on the fly.

For the most part, the use of this imaging server system description in this preferred embodiment will concentrate on the first of these domains because this domain is sufficient to demonstrate the area covered by the present invention. The following is an analysis of how the user of the imaging server system would interact with the original resolution raster image data to do what is needed. The techniques described will apply equally to image transcoding and image creation tasks.

First, the layout of the basic user oriented parameters of the domain will be described, then a workflow and then a description of the workflow using the capabilities of the imaging server system. Finally, there are descriptions of some sample configurations that map to actual deployment models.

Raster Image Preparation Parameters

The following table describes the parameters a web site producer may wish to adjust when preparing image data for the traditional web:

| Name | Tag | Values | Description |
|---|---|---|---|
| Source | SRC | URL | This tells the imaging server |
| | | | system where to get its original |
| | | | input data. Note that the URL |
| | | | may be a file, ftp, |
| | | | http or other URL |
| Width | W | 0 . . . | Tells the imaging server system |
| | | MAXWIDTH | how wide an image to produce |
| Height | H | 0 . . . | Tells the imaging server system |
| | | MAXHEIGHT | how tall an image to produce |
| Output | OUTPUT | MIME | Tells the imaging server system |
| | | | what kind of data to create |
| | | | (e.g., JPEG, GIF etc) |
| Com- | COMPRESS | Percentage | Sets compression settings, only |
| pression | | (0 . . . 100%) | valid for OUTPUT types that |
| | | | support it (e.g. JPEG) |
| Crop- | CROP | SCALE, | SCALE - scale the image to fit |
| Rules | | MAX, MIN | W and H |
| | | | MAX - preserve the Aspect ratio |
| | | | and size the image to preserve |
| | | | the longest side |
| | | | MIN - preserve the aspect ratio |
| | | | and size the image to preserve |
| | | | the smallest side |
| Back- | BG | NONE or | Used only when the Aspect |
| ground | | color | Ratio of SRC doesn't match the |
| | | | Aspect Ratio of W × H. Then, |
| | | | NONE suggests to further |
| | | | size the image based on SRC |
| | | | Aspect Ratio, while a color |
| | | | specification indicates that |
| | | | the image should be padded |
| | | | where necessary |
| | | | to W × H with color |

This is representative of the type of parameters that may be specified. Those of average skill in the art can easily add other parameters to achieve different functions. This list does, however, serve to illustrate that there will be a significant number of “levers” for a user to pull to cause the imaging server system to “do the right thing”.

Given the above capabilities, what follows is the mechanism to set these parameters. As a way to decompose the problem, review the most basic approach: encoding the parameters as part of a “QUERY” URL.

For this example, presume that the Domain Company has a web server at www.domain.com and an imaging server system at “clipper.domain.com”. Here is a fragment of a web page that would make use of some of the capabilities of the present invention:

<HTML>

. . .

<IMG

SRC=http://clipper.domain.com/?SRC=http://www.domain.com/products/images/w idget.jpg&H=320&W=240&CROP=MAX>

. . .

</HTML>

This example suggests that the imaging server system will create a 320×240 JPEG (defaulting to the same format as the input), preserving the aspect ratio of the source image and getting the source image from a directory on www.domain.com.

In this particular case, the URL used as the SRC for the IMG tag isn't too complicated. If we wanted to set more parameters though, it would begin to get somewhat more complicated and error prone. In addition, as more and more capabilities get used, it becomes even more complicated to create a correct URL.

The need to make complex transformations is addressed by this embodiment of the invention associated with the development of a server system dealing with images.

Clearly, an approach that depends solely on URL encoding can prove cumbersome. What is needed is a way to make the server smarter about what it serves, so that fewer things need to be specified in the URL.

In the simplest case, one could just tell the imaging server system some default settings (compression, aspect ratio behaviors and the like). For these simple cases, this would suffice. Using this technique one could probably reduce most imaging server system URLs to just adding the SRC's W & H parameters. If all of the Source images were located in one place further simplification is possible. What is needed is some way to apply a set of settings (“properties”) to a collection of images. It's important that these properties be as easy as possible to apply. Further, it must be true that the use of such properties simplifies in some fashion the URL used to access the image from the imaging server.

The most natural collection mechanism is the directory structure that is implied by most URLs. For example, consider the URL

http://www.domain.com/products/images/router.jpg

In a traditional web server, this URL would imply that the server www.domain.com has a directory called “products”, which has a sub-directory “images” in which can be found the JPEG file “router.jpg”. For modern web application servers, it is less certain that the URL components map to actual directory structure on the server (they may be used as a key into a database instead, for example). The typical thinking is that these are repositories for associated collections of things (e.g. one might well expect “switch.jpg” to be in the same directory as “router.jpg”). This concept can be built on by utilizing a “Virtual Directory” on the imaging server system. “Virtual” in the sense that while the imaging server system will understand them and associate properties with them, they will not actually exist on the server. It is possible to create the following virtual directory on the imaging server system:

http://clipper.domain.com/products/images/

Once this virtual directory was created, the following properties with may be associated with it:

SRC=http://www.domain.com/products/images/${FILE}.tif

COMPRESS=50%

W=640

H=480

Now, it is possible to embed the following simple URL into the HTML page:

<IMG SRC=http://clipper.domain.com/products/images/router.jpg>

Having this URL presented to it would cause the imaging server system to behave in the following manner. It would take the “FILE” portion of the URL presented to it (in this case “router”) and substitute it into the SRC property, creating the real SRC property http://www.domain.com/products/images/router.tif. Note that the Virtual directory path on the imaging server system and the “real” directory path on the web server match each other. This, of course, is convenient but not required. The imaging server system would read in that source TIFF file (input type being derived from the SRC file extension) and produce a 640×480, 50% Compressed JPEG (output type being derived from the input URL extension). Put another way, the Web site developer can fill a server directory with all of the uncompressed TIFFs that will be needed, and simply by creating and using an appropriately configured imaging server system Virtual Directory, get JPEGS automatically produced for Web Browser use. Further, at some future time, should bandwidth become an issue, the virtual directory could be changed to use 80% compression for all images—reducing bandwidth usage but obviating the need to go and regenerate all images on the site.

Hierarchical Properties

The above scheme adequately provides some useful capabilities and is easily implemented based on the usage of a well-configured imaging server system. There are however other embodiments possible.

As noted earlier, the implied directory structure embodied by a URL provides a hierarchy; there is a “contained by” or “child of” relationship between the virtual directories. New capabilities can be built based on this. Continuing from the previous example, the following new imaging server system virtual directory may be created.

http://clipper.domain.com/products/images/thumbnails/

Setting these properties:

W=160

H=120

Developing a configuration so that any virtual directory can inherit the properties of its parents unless those properties are overridden creates a very useful capability. In this case, while making no changes on the web server itself, there are automatically “created” thumbnails for every image that is stored there by simply referencing them this way in the HTML page:

<IMG SRC=http://clipper.domain.com/products/images/thumbnails/router.jpg>

The traditional “click the thumbnail to view a full size image” can now be easily coded as:

<A HREF=http://clipper.domain.com/products/images/router.jpg><IMG

SRC=http://clipper.domain.com/products/images/thumbnails/router.jpg></A>

All of this is done without making a single change on the primary web server.

Floating Directories

This power can be extended even further. Consider the possibility of being able to specify virtual directories as follows:

http://clipper.domain.com/*/thumbnails/

Where SRC is set to something like

http://www.domain.com/${DIRS}/../${FILE}.${EXT}

This would mean that any time a URL was presented to the imaging server system that ended with “thumbnails”, the server would look in that directory's virtual “parent” (that's the “*” notation) for the specified input file. For example if the imaging server system received:

http://clipper.domain.com/catalog/photos/thumbnails/hub.jpg

It would get its source data from

http://www.domain.com/catalog/photos/hub.jpg

and, again, create a “thumbnail” image. This has the effect of creating thumbnails for all of the images on a web site.

Specialized Settings

There will be occasions when the settings of a virtual directory aren't quite right for a particular image. In that case, the ability to set properties in the URL itself is still valuable:

http://clipper.domain.com/catalog/photos/thumbnails/hub.jpg?W=175&H=175

would use all of the “thumbnail” settings but would use a Width of 175 and an Height of 175 for this particular image.

Other Uses

While the examples presented primarily focus on adjusting image size (and, to a lesser extent, output format) other uses are possible. One could imagine creating virtual directories (floating or absolute) called, for example “PocketExplorer” that would automatically apply a set of properties that were appropriate for Microsoft's Windows CE Browsers. Similarly, an “iMode” directory could handle transcoding for Japan's iMode telephones. This example can be extended. Consider a property called “BROWSERDETECT”. This would be a Boolean, which if TRUE, would cause Clipper to examine the browser ID string and look up a set of properties associated with that string. These properties would probably be applied after the last set of virtual directory properties but before any URL properties. It's easy to imagine as part of any product offering that “pre-cooked” property settings for typical scenarios would be made available. It is also important to provide users the ability import and export properties and to copy properties from one entity to another.

Other Conditions and Properties Rule Settings

Using the basic set of conditions previously mentioned such as browser type, device type, bandwidth of connection (both of the device and of the device's associated network), network load, cookies placed in requestors browser, and URL path and file name, the network administrator can designate the properties the image should possess by using a point and click user-interface. The resulting rules, that reside in the request manager, are based on the particular set of conditions accompanying the image request, and are viewed in a hierarchical list. The properties that will prevail in a conflict of properties appearing in the later rules of the rule set. It is also possible to use a “Query URL” string rule that can override any properties set by the above rule set.

The properties currently modifiable in this embodiment comprise image size and width, aspect ratio, JPEG quality and type, GIF palette type and number of colors, transparency, background color, or in the edit mode whether the auto fix command, flip command, rotate command, and grayscale command should be engaged. Of course, virtually any imaging operation could be included as a property. In the present embodiment the output image formats presently comprise PNG, WBMP, JPEG and GIF. In other embodiments, easily added by those skilled in the art, almost any format can be the output.

The Image Rendering Engine

There are many available methods of image rendering, mostly comprising image rendering engines, that are capable of transforming images into different sizes and formats. Those rendering engines can convert images into file formats such as JPEG, GIF, BMP, TIFF, PNG, and PSD. For GIFs, the imaging server system under discussion, supports palettes (optimized, fixed, custom, and hybrid), interlaced, transparency, matte, and dithering. For JPEG, the imaging server system supports quality, progressive, color space (RGB and grayscale) and matte. The imaging server system also executes image manipulation functions such as rotate, auto fix, flip, and grayscale. The image rendering engine manipulates specific images based on the rules created by the IT or Web staff. The rendering engine requests an original image from the appropriate location. The cache ensures quick delivery of images, relieves Web servers from image serving tasks, and enhances the performance of existing cache systems. The imaging server system also supports 3rd-party cache systems such as “edge” cache. The term “edge” is used to describe the network access points or points of presence—on the “edge” of the major Internet backbone. By utilizing “edge-services” such as cache, Web content is placed closer to users, reducing the number of routing and switching hops that are required to retrieve content.

Process Flow

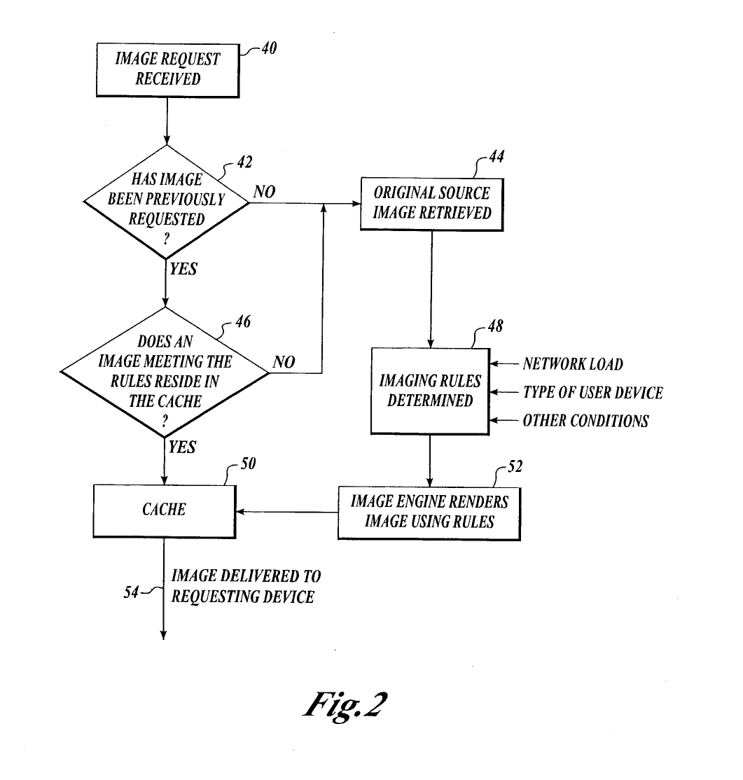

FIG. 2 shows the process flow. The image request is received 40, then there is a determination of whether the image has been previously requested 42, if “no” then an original source image is retrieved 44, the imaging rule set is determined 48 and the imagine engine 52 renders the image using these rules. The appropriate image is then delivered to the cache 50 for transmission 54. Once the imaging server system has delivered the image, the image will now reside in the cache system 50 and any subsequent requests for that image will be handled by the cache 50. If an image with the correct properties has been previously requested then a determination 46 is made as to whether that image still resides in the cache 50. If “yes”, the cached image is delivered. If no image having the appropriate properties is in the cache then an original source image is retrieved 44, the rules determined 48, the imaging engine engaged 52, and the resulting image sent to the cache 50 for delivery 54.

Sample Devices

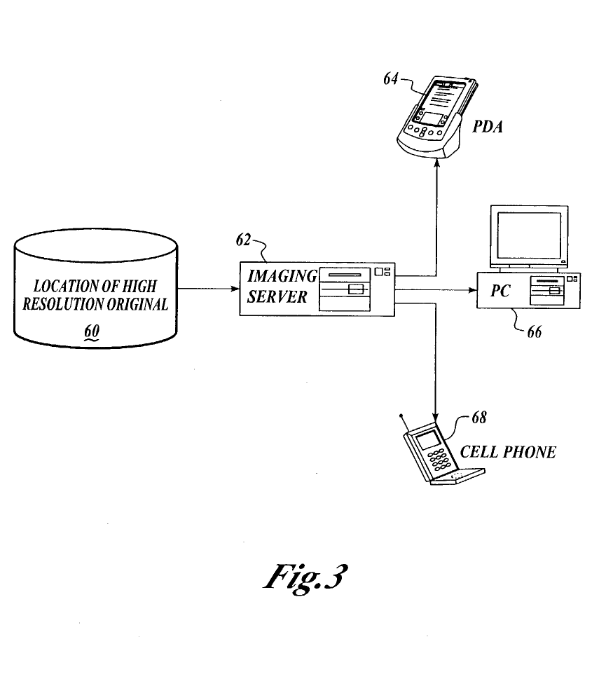

FIG. 3 shows a sample of the devices that may be used to request an image from a networked server. The imaging server system 62 can modify the original image 60 properties to an image that is specifically suitable for a PDA 64, or using another set of properties deliver a image specifically suitable for a PC, or using a third set of properties delivering an image specifically suitable for a cell phone 68.

The preferred embodiment comprising this imaging server system also provides a management console that allows administrators to securely control, configure, and monitor the imaging server system from any Web browser. Listed below are some of the management functions provided:

Define users/permissions Error logs Ratio Cache/New

Manage passwords Invalid links Images per day

Network configuration Cache access logs Images per hour

Rule set configuration HTTP server access logs

Most requested images

Server startup/shutdown Rule usage logs

Most popular browsers

Server/cache configuration

Most frequently used rules

Server demand history

Rule settings in priority order.

### CONCLUSION

The process of creating, manipulating, and managing multimedia content is expensive and time-consuming. Maintaining acceptable site performance and delivering content to a variety of devices and connection speeds have presented significant challenges to IT and Web production staff. The present invention changes that by providing a secure, robust server system that reduces the costs of multimedia production, enhances network site performance, and dynamically delivers multimedia to any device.

The present examples and description are to be considered as illustrative and not restrictive, and the invention is not limited to the details given herein, but may be modified within the scope of the appended claims along with their full scope of equivalents.

We claim:

1. A method for transmitting multimedia content in a networked environment comprising the steps of:
a) receiving a request for multimedia content; and
b) determining an appropriate set of multimedia properties for transmission of said requested multimedia content; and
c) transmitting said requested multimedia content with said multimedia content incorporating said appropriate set of multimedia properties.

2. The method of claim 1 wherein the appropriate set of properties is determined by one or more conditions associated with the request for the multimedia content.

3. The method of claim 2 wherein the one or more conditions associated with the request for the multimedia content includes the type of user device requesting the multimedia content.

4. The method of claim 2 wherein the one or more conditions associated with the request for the multimedia content is a substantive determination of the device's and the device's associated network's data transmission speed

5. The method of claim 2 wherein the one or more conditions associated with the request for the multimedia content includes the network load at the time the multimedia content is requested.

6. The method of claim 2 further comprising the steps of predetermining a rule set against which is compared the one or more conditions associated with the request for the multimedia content.

7. The method of claim 2 further comprising the steps of predetermining a cache of multimedia content with the appropriate sets of properties already applied and making that cache of multimedia content available for transmission.

8. The method of claim 7 wherein, if no multimedia content with the appropriate set of properties is available in the cache, then retrieving non-conditioned multimedia content, applying the appropriate set of properties to that non-conditioned multimedia content, and subsequently transmitting that multimedia content now incorporating the appropriate set of properties.

9. In a networked environment a system for transmitting multimedia content with the appropriate properties, with said properties determined by the conditions prevailing at the time the multimedia content is requested, comprising:
a) a server receiving the request; and
b) said server using a predetermined rule set for determining what multimedia content properties are appropriate for transmission; and
c) an multimedia content rendering engine capable of taking non-conditioned multimedia content and rendering the non-conditioned multimedia content into conditioned multimedia content with the appropriate properties; and
d) said server then delivering said conditioned multimedia content.

10. The system of claim 9 further including a cache of predetermined multimedia content already incorporating the appropriate properties for transmission, whereby the server, upon determining that appropriate multimedia content is already available in said cache, retrieves said appropriate multimedia content for transmission.

11. The system of claim 9 wherein the rule set for determining what multimedia content properties are appropriate for transmission uses as one of the factors the type of client device requesting the multimedia content.

12. The system of claim 9 wherein the rule set for determining what multimedia content properties are appropriate for transmission uses as one of the factors for that determination the requesting device's and the requesting device's associated network's data transmission speed.

13. The system of claim 9 wherein the rule set for determining what multimedia content properties are appropriate for transmission uses as one of the factors for that determination the current network load at the time the multimedia content is requested.

14. In a networked environment a system for transmitting multimedia content with the appropriate properties, with said properties determined by the conditions prevailing at the time the multimedia content is requested, comprising:
a) means for receiving the request; and
b) means for using a predetermined rule set for determining what multimedia content properties are appropriate for transmission; and
c) means for taking a non-conditioned multimedia content and rendering the non-conditioned multimedia content into a conditioned multimedia content with the appropriate properties; and
d) means for transmitting said conditioned multimedia content to the requesting device.

15. The system of claim 14 further including means for caching predetermined multimedia content already incorporating the appropriate properties for transmission, whereby the server, upon determining that the appropriate multimedia content is already available in said cache, retrieves said appropriate multimedia content for transmission.

16. The system of claim 14 wherein the means for generating the rule set for determining what multimedia content properties are appropriate for transmission uses as one of the factors the type of client device requesting the multimedia content.

17. The system of claim 14 wherein the means for generating a rule set for determining what multimedia content properties are appropriate for transmission uses as one of the substantive factors for that determination the client device's and the client device's associated network's data transmission speed.

18. The system of claim 14 wherein the means for generating a rule set for determining what multimedia content properties are appropriate for transmission uses as one of the factors for that determination the current network load at the time the multimedia content is requested.

19. A method for transmitting images in a networked environment comprising the steps of:
a. receiving a request for the image; and
b. determining an appropriate set of image properties for transmission of said requested image wherein said appropriate set of image properties comprise a selection from: the type of device requesting the image, the network load at the time the image is requested, the content of a cookie read from the requesting device and the bandwidth available to deliver the image to the requesting device; and
c. determining if an image with the appropriate set of properties is available in a cache of images; and
d. if no such image with the appropriate set of properties is available, then sending an original image to an image rendering engine to produce an image with said appropriate set of properties; and
e. delivering said image with the appropriate set of properties to the requesting device.

20. A method for transmitting images in a networked environment comprising the steps of:
a. receiving a request for the image; and
b. determining an appropriate set of image properties for transmission of said requested image with said determination overridden by the image property parameters embedded in the requested image URL's query string; and
c. determining if an image with the appropriate set of properties is available in a cache of images; and
d. if no such image with the appropriate set of properties is available, then sending an original image to an image rendering engine to produce an image with said appropriate set of properties; and
delivering said image with the appropriate set of properties to the requesting device.

21. A computer readable medium containing instructions for controlling transmitted multimedia content properties, the instructions comprising the steps of:
a) receiving a request for the multimedia content; and
b) determining an appropriate set of multimedia content properties for transmission of said requested multimedia content; and
c) transmitting said requested multimedia content with said multimedia content incorporating said appropriate set of multimedia content properties.
